(19) United States
(12) Patent Application Publication
(10) Pub. No.: US 2024/0093384 A1
(43) Pub. Date: Mar. 21, 2024

(54) WATER ELECTROLYSIS SYSTEM

(71) Applicant: TOYOTA JIDOSHA KABUSHIKI KAISHA, Toyota-shi (JP)

(72) Inventors: Kimihiro TSUCHIYA, Fuji-shi (JP); Keiichi OKUBO, Susono-shi (JP)

(73) Assignee: TOYOTA JIDOSHA KABUSHIKI KAISHA, Toyota-shi (JP)

(21) Appl. No.: 18/463,918

(22) Filed: Sep. 8, 2023

(30) Foreign Application Priority Data
Sep. 9, 2022 (JP) 2022-143818

(51) Int. Cl. C25B 1/04; C25B 15/08

(52) U.S. Cl. CPC C25B 1/04; C25B 15/081; C25B 15/083

(57) ABSTRACT

A water electrolysis system including: a water electrolysis cell; a water supply device that supplies water to an oxygen electrode of the water electrolysis cell; a water supply channel that connects the water electrolysis cell and the water supply device and through which the water supplied from the water supply device to the oxygen electrode flows; a gas-liquid separator that separates the water and a gaseous component discharged from the oxygen electrode; a water discharge channel that connects the water electrolysis cell and the gas-liquid separator and through which the water and a gaseous component discharged from the oxygen electrode flow; and a recombiner disposed between the water electrolysis cell and the gas-liquid separator in the water discharge channel. The recombiner includes a recombination catalyst that reacts hydrogen and oxygen, and the water electrolysis cell and the recombiner are electrically insulated from each other.

### CROSS-REFERENCE TO RELATED APPLICATION

This application claims priority to Japanese Patent Application No. 2022-143818 filed on Sep. 9, 2022 incorporated herein by reference in its entirety.

### BACKGROUND

### 1. Technical Field

The present application relates to a water electrolysis system.

### 2. Description of Related Art

In recent years, hydrogen has been attracting attention as a CO₂-free energy source. A method for producing hydrogen includes alkaline water electrolysis and PEM type water electrolysis (PEM: Polymer Electrolyte Membrane). Among the above, the PEM type water electrolysis is attracting attention due to its high efficiency.

When water electrolysis is carried out, a so-called hydrogen cross over occurs in which hydrogen generated in a cathode catalyst layer (hydrogen electrode catalyst layer) permeates an electrolyte membrane and moves to an anode catalyst layer (oxygen electrode catalyst layer). With the above, hydrogen is mixed with oxygen generated on the anode catalyst layer side, and a hydrogen concentration in oxygen increases. Then, when the hydrogen concentration in oxygen exceeds a predetermined concentration (for example, about 4%), there is a possibility of an abnormal reaction. Therefore, a technique for suppressing an increase in the hydrogen concentration in oxygen is desired.

According to S. A. Grigorievet. al., “Hydrogen Safety Aspects Related To High-Pressure Polymer Electrolyte Membrane Water Electrolysis”, International Journal of Hydrogen Energy, 34 (2009), pp. In 5986-5991, a water electrolysis system is disclosed in which water discharged from a water electrolysis cell is separated into water and oxygen (including hydrogen that crosses over) by a gas-liquid separator, the separated oxygen is supplied to a recombiner equipped with a recombination catalyst, and the oxygen and hydrogen in the recombiner are recombined to generate water, thereby suppressing an increase in the hydrogen concentration in oxygen.

In addition, in Japanese Unexamined Patent Application Publication No. 2019-167619 (JP 2019-167619 A) and Japanese Unexamined Patent Application Publication (Translation of PCT Application) No. 2020-514528 (JP 2020-514528 A), a technique in which, in a membrane electrode assembly for PEM type water electrolysis, hydrogen and oxygen that are moved by crossover are reacted using a recombination catalyst to suppress an increase in the hydrogen concentration in oxygen is disclosed.

### SUMMARY

As described above, water is produced when oxygen and hydrogen are reacted by a recombination catalyst. According to S. A. Grigorievet. al., “Hydrogen Safety Aspects Related To High-Pressure Polymer Electrolyte Membrane Water Electrolysis”, International Journal of Hydrogen Energy, 34 (2009), pp. In No. 5986-5991, the recombination reaction is carried out in the gas phase, and therefore water is produced and condensed on the surface of the recombination catalyst. Then, the condensed water hinders hydrogen and oxygen from being supplied to the surface of the recombination catalyst, thereby reducing the efficiency of the recombination reaction. As a result, the hydrogen concentration in oxygen cannot be sufficiently reduced.

Therefore, the present disclosure provides a water electrolysis system that suppresses an increase in a hydrogen concentration in oxygen due to hydrogen crossover.

One aspect provided by the present disclosure provides a water electrolysis system including: at least one water electrolysis cell; a water supply device configured to supply water to an oxygen electrode of the water electrolysis cell; a water supply channel configured to connect the water electrolysis cell and the water supply device and configured such that the water supplied from the water supply device to the oxygen electrode of the water electrolysis cell flows; a gas-liquid separator configured to separate the water and a gaseous component discharged from the oxygen electrode of the water electrolysis cell; a water discharge channel configured to connect the water electrolysis cell and the gas-liquid separator and configured such that the water and the gaseous component supplied from the oxygen electrode of the water electrolysis cell flow; and a recombiner disposed between the water electrolysis cell and the gas-liquid separator in the water discharge channel. The recombiner includes a recombination catalyst that reacts hydrogen and oxygen, and the water electrolysis cell and the recombiner are electrically insulated from each other.

In the above water electrolysis system, the recombination catalyst may be platinum or a platinum alloy, and an alloy element in the platinum alloy may be at least one metal element selected from a group consisting of Co, Ni, Fe, Mn, Ta, Ti, Hf, W, Zr, Nb, Al, Sn, Mo and Si.

In the above water electrolysis system, the recombiner may include a housing and a mesh-shaped metal body in which the recombination catalyst is attached to a surface.

In the above water electrolysis system, a potential of the recombiner may be 0.8 V or less.

According to the water electrolysis system of the present disclosure, an increase in the hydrogen concentration in oxygen due to hydrogen crossover can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a water electrolysis system;

FIG. 2 is an example of an embodiment of a recombiner;

FIG. 3 is a block diagram of a water electrolysis system of the related art;

FIG. 4 is a diagram showing a recombination reaction in a recombiner of the water electrolysis system of the related art; and

FIG. 5 shows measurement results of hydrogen concentration in oxygen in an example and first and second comparative examples.

### DETAILED DESCRIPTION OF EMBODIMENTS

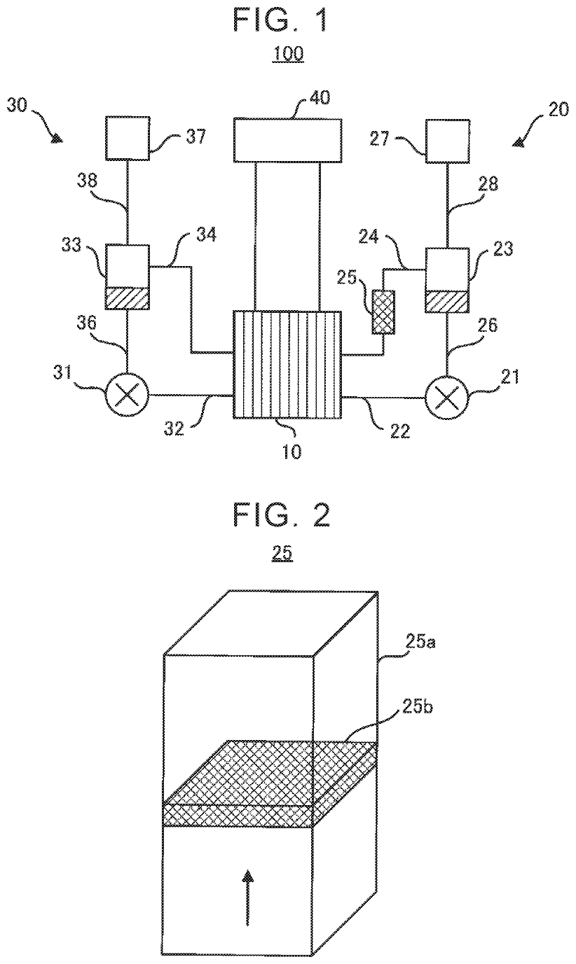

A water electrolysis system according to the present disclosure will be described using a water electrolysis system 100 that is one embodiment. FIG. 1 shows a block diagram of the water electrolysis system 100.

As shown in FIG. 1, the water electrolysis system 100 includes at least one water electrolysis cell 10, an oxygen electrode piping portion 20 disposed on the oxygen electrode side of the water electrolysis cell, a hydrogen electrode piping portion 30 disposed on the hydrogen electrode side of the water electrolysis cell, and a power source 40.

### Water Electrolysis Cell 10

The water electrolysis cell 10 is a device for producing hydrogen and oxygen by electrolyzing water. The water electrolysis system 100 may include one or more water electrolysis cells. Typically, the water electrolysis system 100 includes a plurality of the water electrolysis cells 10 from the viewpoint of improving water electrolysis efficiency.

The water electrolysis cell 10 includes an oxygen electrode and a hydrogen electrode. Oxygen is generated from the oxygen electrode and hydrogen is generated from the hydrogen electrode when water is supplied and voltage is applied to the oxygen electrode of the water electrolysis cell 10. As described above, the electrolysis reaction of water by the water electrolysis cell 10 only needs supply of water to the oxygen electrode, and there is no need to supply water to the hydrogen electrode. However, the supply of water to the hydrogen electrode is not prohibited, and water may be supplied to the hydrogen electrode, for example, for system cooling. In the water electrolysis system 100, water is supplied to the hydrogen electrode for the purpose of system cooling.

Oxygen generated at the oxygen electrode by water electrolysis is discharged together with water, and is separated into oxygen and water in an oxygen electrode gas-liquid separator 23. Hydrogen generated at the hydrogen electrode by water electrolysis may be recovered without change. However, in the water electrolysis system 100 in which water is supplied to the hydrogen electrode, the hydrogen is discharged together with the water, and is separated into oxygen and water in a hydrogen electrode gas-liquid separator 33. Even when water is not supplied to the hydrogen electrode, water enters the hydrogen electrode from the oxygen electrode through an electrolyte layer. Therefore, hydrogen is discharged together with the water, and the hydrogen may be separated into hydrogen and water in the hydrogen electrode gas-liquid separator 33.

The water electrolysis cell 10 includes an oxygen electrode water inlet for supplying water to the oxygen electrode and an oxygen electrode water outlet for discharging water from the oxygen electrode. Further, the water electrolysis system 100 is configured to supply water to the hydrogen electrode. Therefore, the water electrolysis cell 10 includes a hydrogen electrode water inlet for supplying water to the hydrogen electrode and a hydrogen electrode water outlet for discharging water from the hydrogen electrode. When there is a plurality of the water electrolysis cells 10, the water supplied to the oxygen electrode water inlet and the hydrogen electrode water inlet is supplied to the oxygen electrode and hydrogen electrode of each water electrolysis cell 10, and is discharged from the oxygen electrode water outlet and the hydrogen electrode water outlet.

The type of the water electrolysis cell 10 is not particularly limited. However, a PEM type water electrolysis cell may be adopted from the viewpoint of improving water electrolysis efficiency. Hereinafter, the configuration of the PEM type water electrolysis cell will be briefly described below.

The PEM type water electrolysis cell includes a membrane electrode assembly and a pair of separators, the separators disposed on respective sides of the membrane electrode assembly. Moreover, the PEM type water electrolysis cell may include a gas diffusion layer disposed between the membrane electrode assembly and the separator. Known gas diffusion layer and separator can be used as appropriate.

The membrane electrode assembly includes an electrolyte layer, an oxygen electrode catalyst layer disposed on one side of the electrolyte layer, and a hydrogen electrode catalyst layer disposed on the other side of the electrolyte layer.

The electrolyte layer is not particularly limited as long as the electrolyte layer has hydrogen ion conductivity. For example, a polymer electrolyte containing a sulfonic acid group may be used. From the viewpoint of durability, the polymer electrolyte may be a fluoropolymer. For example, the polymer electrolyte may be a perfluorocarbon polymer.

The oxygen electrode catalyst layer contains an oxygen electrode catalyst capable of generating oxygen by water electrolysis. The oxygen electrode catalyst is not particularly limited, and examples thereof include a metal catalyst. The metal catalyst includes, for example, a metal catalyst that includes Pt, Ru, Rh, Os, Ir, Pd, and Au in its composition. The metal catalyst may be an oxide of the metals above. The oxygen electrode catalyst may be an electrically conductive carrier supporting a metal catalyst (metal-supported catalyst). Moreover, the oxygen electrode catalyst layer may contain an ionomer having proton conductivity. The ionomer is not particularly limited. Examples include a proton-conducting polymer. Examples of the proton-conducting polymer include fluoroalkyl polymer such as polytetrafluoroethylene, and fluoroalkyl polymer such as perfluoroalkylsulfonic acid polymer.

The hydrogen electrode catalyst layer contains a hydrogen electrode catalyst capable of generating hydrogen by water electrolysis. The hydrogen electrode catalyst is not particularly limited, and examples thereof include a metal catalyst. The metal catalyst includes, for example, a metal catalyst that includes Pt, Ru, Rh, Os, Ir, Pd, and Au in its composition. The metal catalyst may be an oxide of the metals above. The hydrogen electrode catalyst may be an electrically conductive carrier supporting a metal catalyst (metal-supported catalyst). The type of carrier is not particularly limited, and examples thereof include carbon carriers. Moreover, the hydrogen electrode catalyst layer may contain an ionomer having proton conductivity. The ionomer is not particularly limited. Examples include the ionomer described above.

### Oxygen Electrode Piping Portion 20

The oxygen electrode piping portion 20 has a role of supplying water to the oxygen electrode of the water electrolysis cell and recovering oxygen generated at the oxygen electrode. As shown in FIG. 1, the oxygen electrode piping portion 20 includes an oxygen electrode water supply device 21, an oxygen electrode water supply channel 22, the oxygen electrode gas-liquid separator 23, an oxygen electrode water discharge channel 24, a recombiner 25, an oxygen electrode circulation channel 26, an oxygen tank 27, and an oxygen supply channel 28.

The oxygen electrode water supply device 21 is a device that supplies water to the oxygen electrode of the water electrolysis cell 10. The water may be supplied to the water electrolysis cell 10 under pressure so as to circulate the water. Examples of the oxygen electrode water supply device 21 include a pump.

The oxygen electrode water supply channel 22 is piping that connects the oxygen electrode of the water electrolysis cell 10 and the oxygen electrode water supply device 21 and through which the water supplied from the oxygen electrode water supply device 21 flows. In FIG. 1, the oxygen electrode water supply channel 22 connects the oxygen electrode water inlet of the water electrolysis cell 10 and the oxygen electrode water supply device 21, and the water supplied from the oxygen electrode water supply device 21 is supplied to the oxygen electrode of the water electrolysis cell 10 via the water supply channel 22 and the oxygen electrode water inlet.

The oxygen electrode gas-liquid separator 23 is a device that separates water and a gaseous component discharged from the oxygen electrode of the water electrolysis cell 10. The gaseous component (oxygen electrode gaseous component) in the oxygen electrode piping portion 20 is oxygen generated at the oxygen electrode of the water electrolysis cell 10. However, the gaseous component may contain a very small amount of hydrogen that is generated at the hydrogen electrode of the water electrolysis cell 10 and crosses over through the electrolyte layer. Accordingly, the gaseous component may contain only oxygen or may contain oxygen and hydrogen. The water separated by the oxygen electrode gas-liquid separator 23 is sent to the oxygen electrode water supply device 21 via the oxygen electrode circulation channel 26 and reused for the water electrolysis reaction. The gaseous component separated by the oxygen electrode gas-liquid separator 23 is sent to the oxygen tank 27 via the oxygen supply channel 28 and stored therein. The gaseous component separated by the oxygen electrode gas-liquid separator 23 may be discharged to the atmosphere.

The oxygen electrode water discharge channel 24 is piping that connects the water electrolysis cell 10 and the gas-liquid separator 23 and through which the water and gaseous component discharged from the oxygen electrode of the water electrolysis cell 10 flow. In FIG. 1, the oxygen electrode water discharge channel 24 connects the oxygen electrode water outlet of the water electrolysis cell 10 and the oxygen electrode gas-liquid separator 23, and the water discharged from the water electrolysis cell 10 is supplied to the oxygen electrode gas-liquid separator 23 via the oxygen electrode water outlet and the oxygen electrode water discharge channel 24 (including the recombiner to be described later).

A recombiner 25 is disposed between the water electrolysis cell 10 and the oxygen electrode gas-liquid separator 23 in the oxygen electrode water discharge channel 24. The reason for disposing the recombiner 25 between the water electrolysis cell 10 and the oxygen electrode gas-liquid separator 23 will be described later.

The recombiner 25 includes a recombination catalyst that reacts hydrogen and oxygen. As described above, oxygen is generated by water electrolysis reaction at the oxygen electrode of the water electrolysis cell 10. Hydrogen is generated by a water electrolysis reaction at the hydrogen electrode of the water electrolysis cell 10, flows through the electrolyte layer, and crosses over from the hydrogen electrode side to the oxygen electrode side. The hydrogen and oxygen above are discharged from the oxygen electrode of the water electrolysis cell 10 in a gaseous form or in a state of being dissolved in water. The hydrogen and oxygen then reach the recombination catalyst provided in the recombiner 25 and undergo a recombination reaction. With the configuration above in which the recombiner 25 is provided with the recombination catalyst, the oxygen and hydrogen discharged from the oxygen electrode of the water electrolysis cell 10 can be reacted with each other, and the hydrogen on the oxygen electrode side can be consumed. Therefore, a hydrogen concentration in the gas (oxygen) separated from the gas-liquid separator can be reduced.

The recombination catalyst is not particularly limited as long as the recombination catalyst can catalyze the recombination reaction between oxygen and hydrogen. Examples include platinum or a platinum alloy. The alloy element in the platinum alloy is at least one metal element selected from the group consisting of Co, Ni, Fe, Mn, Ta, Ti, Hf, W, Zr, Nb, Al, Sn, Mo and Si. Also, the recombination catalyst may be carried on a carrier. The carrier is not particularly limited. However, from the viewpoint of enhancing the activity of the recombination reaction, a carbon carrier may be used.

The mode of the recombination catalyst disposed in the recombiner 25 is not particularly limited as long as the recombination catalyst can catalyze the recombination reaction above. For example, the recombination catalyst may simply be placed on the inner surface of the recombiner 25. From the viewpoint of enhancing recombination reaction efficiency, a mesh-shaped metal body in which the recombination catalyst is attached to its surface may be disposed in the recombiner 25.

FIG. 2 shows an example of the embodiment. As shown in FIG. 2, the recombiner 25 includes a housing 25a and a mesh-shaped metal body 25b in which the recombination catalyst is attached to its surface. The mesh-shaped metal body 25b is disposed in a direction orthogonal to a water flow direction (a direction orthogonal to a longitudinal direction of the housing 25a), and the water and gaseous component pass through pores of the mesh-shaped metal body 25b. At this time, the recombination reaction occurs on the surface of the recombination catalyst.

The shape of the housing 25a is not particularly limited, and may be a quadrangular prism shape or a cylindrical shape. Further, a portion of the oxygen electrode water discharge channel 24 may be regarded as the housing 25a. In this case, the mesh-shaped metal body 25b only needs to be disposed in the oxygen electrode water discharge channel 24.

the mesh-shaped metal body 25b includes a base material and a recombination catalyst attached to the surface thereof. The recombination catalyst only needs to be disposed on at least part of the surface of the mesh-shaped metal body. However, the recombination catalyst may be disposed on the entire surface from the viewpoint of improving efficiency. The mesh-shaped metal body is not particularly limited as long as the mesh-shaped metal body is a metal provided with a mesh structure. The type of metal is not particularly limited, and examples thereof include stainless steel (SUS) and titanium. Titanium may be selected from the viewpoint of corrosion resistance. The pore size of the mesh structure is not particularly limited as long as the pore size allows water to pass through. The thickness of the mesh-shaped metal body is also not particularly limited, and may be appropriately set in accordance with the purpose such as recombination reaction efficiency.

Further, the water electrolysis cell 10 and the recombiner 25 are required to be electrically insulated from each other. This is because, the oxygen electrode of the water electrolysis cell 10 has a high potential (e.g., 1.2 V or more), and when the water electrolysis cell 10 and the recombiner 25 are electrically connected to each other, the potential of the recombiner 25 becomes equal to the potential of the oxygen electrode of the water electrolysis cell 10, and this oxidizes the surface of the recombination catalyst and deteriorates the efficiency of the catalytic reaction. More specifically, the requirement is that the recombiner 25 (recombination catalyst) and the water electrolysis cell 10 are electrically insulated from each other and the potential of the recombiner 25 (recombination catalyst) is preferably 1.2V or less, and more preferably 0.8 V or less. With the above, oxidation of the surface of the recombination catalyst can be suppressed, and a state of high recombination reaction efficiency can be maintained.

For example, it is conceivable that the gas diffusion layer contained in the oxygen electrode of the water electrolysis cell is coated with the recombination catalyst (for example, a platinum catalyst) without providing the recombiner 25 to cause the recombination reaction in the water electrolysis cell 10. However, in this case, since the gas diffusion layer is electrically connected to the oxygen electrode, the surface of the recombination catalyst is gradually oxidized and the recombination reaction efficiency is deteriorated. As described above, when the water electrolysis cell and the recombination catalyst are electrically connected to each other, it is not possible to maintain the state of high recombination reaction efficiency.

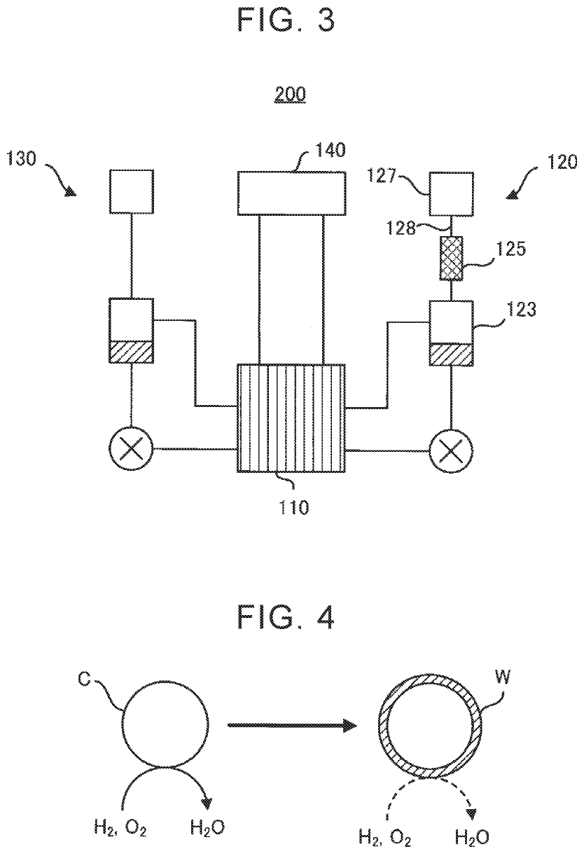

Here, the reason for disposing the recombiner 25 between the water electrolysis cell 10 and the oxygen electrode gas-liquid separator 23 is described. FIG. 3 shows a block diagram of a water electrolysis system 200 of the related art. The water electrolysis system 200 imitates the water electrolysis system described in S. A. Grigorievet. al., “Hydrogen Safety Aspects Related To High-Pressure Polymer Electrolyte Membrane Water Electrolysis”, International Journal of Hydrogen Energy, 34 (2009), pp. In No. 5986-5991.

As shown in FIG. 3, the water electrolysis system 200 includes a water electrolysis cell 110, an oxygen electrode piping portion 120, a hydrogen electrode piping portion 130, and a power source 140. The difference between the water electrolysis system 100 and the water electrolysis system 200 is that a recombiner 125 is disposed between the oxygen electrode gas-liquid separator 123 and an oxygen tank 127 in the oxygen electrode piping portion 120. Other configurations are the same. As described above, the gaseous component separated by the oxygen electrode gas-liquid separator 123 is sent to the oxygen supply channel 128. Therefore, the recombination reaction in the recombiner 125 takes place only in the gaseous phase.

FIG. 4 shows the recombination reaction in a recombination catalyst C of the water electrolysis system 200 of the related art. As shown in FIG. 4, since the recombination reaction of the related art takes place in the gaseous phase, water is produced on the surface of the recombination catalyst C and condenses over time. Then, this condensed water W hinders hydrogen and oxygen from being supplied to the surface of the recombination catalyst C, thereby reducing the efficiency of the recombination reaction. As a result, an issue that the hydrogen concentration in oxygen cannot be sufficiently reduced arises.

On the other hand, in the water electrolysis system 100, the recombiner 25 is disposed between the water electrolysis cell 10 and the oxygen electrode gas-liquid separator 23, and therefore the recombination reaction occurs in water. Specifically, the water (unreacted water) discharged from the oxygen electrode of the water electrolysis cell 10 contains dissolved hydrogen and oxygen, and therefore the hydrogen and oxygen reach the recombination catalyst and undergo the recombination reaction in water. When the recombination reaction occurs, water (condensed water) is generated. However, unlike the related art, the condensed water is caused to flow into the unreacted water passing through the recombiner 25, and the unreacted water comes into contact with the recombination catalyst all the time. Therefore, with the configuration in which the recombiner 25 is disposed between the water electrolysis cell 10 and the oxygen electrode gas-liquid separator 23, the water electrolysis system 100 can maintain the state of a high recombination reaction efficiency.

Note that, since some of the hydrogen and oxygen discharged from the oxygen electrode of the water electrolysis cell 10 are in a gaseous form, the recombination reaction occurs even when the hydrogen and oxygen reach the recombination catalyst. Even in this case, the generated water (condensed water) is washed away by the unreacted water, whereby the recombination reaction efficiency can be maintained high. Note that, since a large amount of water normally flows and circulates in the oxygen electrode piping portion 20, it is presumed that the recombination reaction mainly occurs in water.

The oxygen electrode circulation channel 26 is piping that connects the oxygen electrode water supply device 21 and the oxygen electrode gas-liquid separator 23 and through which the water discharged from the oxygen electrode gas-liquid separator 23 flows. The oxygen electrode circulation channel 26 is used when water is circulated in the oxygen electrode piping portion 20. Therefore, the oxygen electrode circulation channel 26 is unnecessary when water is not circulated.

The oxygen tank 27 is for storing the gaseous component separated by the oxygen electrode gas-liquid separator 23. Instead of the oxygen tank 27, the gaseous component may be discharged to the atmosphere.

The oxygen supply channel 28 is piping that connects the oxygen electrode gas-liquid separator 23 and the oxygen tank 27 and through which the gaseous component separated by the oxygen electrode gas-liquid separator 23 flows.

### Hydrogen Electrode Piping Portion 30

The hydrogen electrode piping portion 30 has a role of recovering hydrogen generated at the hydrogen electrode. Further, the hydrogen electrode piping portion 30 circulates water within the hydrogen electrode piping portion 30 for system cooling. As shown in FIG. 1, the hydrogen electrode piping portion 30 includes a hydrogen electrode water supply device 31, a hydrogen electrode water supply channel 32, the hydrogen electrode gas-liquid separator 33, a hydrogen electrode water discharge channel 34, a hydrogen electrode circulation channel 36, a hydrogen tank 37, and a hydrogen supply channel 38.

The hydrogen electrode water supply device 31 is a device that supplies water to the hydrogen electrode of the water electrolysis cell 10. The water may be supplied to the water electrolysis cell 10 under pressure so as to circulate the water. Examples of the hydrogen electrode water supply device 31 include a pump.

The hydrogen electrode water supply channel 32 is piping that connects the hydrogen electrode of the water electrolysis cell 10 and the hydrogen electrode water supply device 31 and through which the water supplied from the hydrogen electrode water supply device 31 flows. In FIG. 1, the hydrogen electrode water supply channel 32 connects the hydrogen electrode water inlet of the water electrolysis cell 10 and the hydrogen electrode water supply device 31, and the water supplied from the hydrogen electrode water supply device 31 is supplied to the hydrogen electrode of the water electrolysis cell 10 via the hydrogen electrode water supply channel 32 and the hydrogen electrode water inlet.

The hydrogen electrode gas-liquid separator 33 is a device that separates water and a gaseous component discharged from the hydrogen electrode of the water electrolysis cell 10. The gaseous component (hydrogen electrode gaseous component) in the hydrogen electrode piping portion 30 is hydrogen generated at the hydrogen electrode of the water electrolysis cell 10. However, the gaseous component may contain a very small amount of oxygen that is generated at the oxygen electrode of the water electrolysis cell 10 and crosses over through the electrolyte layer. However, it is known that oxygen is more difficult to cross over than hydrogen. Accordingly, the gaseous component contains hydrogen and may optionally contain oxygen. The water that has passed through the hydrogen electrode gas-liquid separator 33 is sent to the hydrogen electrode water supply device 31 via the hydrogen electrode circulation channel 36 and reused for the water electrolysis reaction. The gaseous component separated by the hydrogen electrode gas-liquid separator 33 is sent to the hydrogen tank 37 via the hydrogen supply channel 38 and stored therein.

The hydrogen electrode water discharge channel 34 is piping that connects the water electrolysis cell 10 and the gas-liquid separator 33 and through which the water and gaseous component discharged from the hydrogen electrode of the water electrolysis cell 10 flow. In FIG. 1, the hydrogen electrode water discharge channel 34 connects the hydrogen electrode water outlet of the water electrolysis cell 10 and the hydrogen electrode gas-liquid separator 33, and the water discharged from the water electrolysis cell 10 is supplied to the hydrogen electrode gas-liquid separator 33 via the hydrogen electrode water outlet and the hydrogen electrode water discharge channel 34.

The hydrogen electrode circulation channel 36 is piping that connects the hydrogen electrode water supply device 31 and the hydrogen electrode gas-liquid separator 33 and through which the water discharged from the hydrogen electrode gas-liquid separator 33 flows. The hydrogen electrode circulation channel 36 is used when water is circulated in the hydrogen electrode piping portion 30. Therefore, the hydrogen electrode circulation channel 36 is unnecessary when water is not circulated.

The hydrogen tank 37 is for storing the gaseous component separated by the hydrogen electrode gas-liquid separator 33.

The hydrogen supply channel 38 is piping that connects the hydrogen electrode gas-liquid separator 33 and the hydrogen tank 37 and through which the gaseous component separated by the hydrogen electrode gas-liquid separator 33 flows.

### Power Source 40

The power source 40 supplies electric power to the water electrolysis cell 10 and is connected to both the oxygen electrode and the hydrogen electrode of the water electrolysis cell 10. The power source 40 as described above is a known power source.

As described above, the water electrolysis system according to the present disclosure has been described using the embodiment. The water electrolysis system according to the present disclosure can suppress an increase in the hydrogen concentration in oxygen due to hydrogen crossover in a manner such that the recombiner is disposed between the water electrolysis cell and the oxygen electrode gas-liquid separator.

Hereinafter, the water electrolysis system according to the present disclosure will be further described using examples.

### Construction of Water Electrolysis System

A water electrolysis system of a first example was constructed following the water electrolysis system 100 shown in FIG. 1. The water electrolysis cell was fabricated by disposing a diffusion layer made of a carbon fiber on the hydrogen electrode side of the membrane electrode assembly shown in Table 1, disposing a diffusion layer in which platinum was vapor-deposited on a surface of a titanium fiber on the oxygen electrode side, and assembling a laminated body obtained into a single cell (both the oxygen electrode and the hydrogen electrode were straight channels) having an electrode area of 1 cm². A recombiner was constructed following FIG. 2. A titanium fiber sintered body having a pore size of 30 μm and a thickness of 200 μm was used as the mesh-shaped metal body 25b, and platinum was vapor-deposited on the surface of the titanium fiber sintered body.

A water electrolysis system of a first comparative example is the same as the water electrolysis system of the first example except for the recombiner.

A water electrolysis system of a second comparative example is constructed following the water electrolysis system 200 of FIG. 3, and the position of disposing the recombiner in the water electrolysis system of the first example is set between the oxygen electrode gas-liquid separator and the oxygen tank.

TABLE 1

| | |
|---|---|
| Oxygen electrode | IrO₂ catalyst (manufactured by Umicore) |
| catalyst layer | Ionomer (manufactured by AGC Inc.) |
| | Weight ratio of Ir to ionomer; 0.3:1 |
| | Ir loading amount: 2.0 mg/cm² |
| Electrolyte | Nafion NR212 (Made by W. L. Gore & Associates |
| layer | G.K.) |
| Hydrogen electrode | Pt/C catalyst (manufactured by Cataler Corporation) |
| catalyst layer | Ionomer (manufactured by AGC Inc.) |
| | Weight ratio of C to ionomer; 1.2:1 |
| | Pt loading amount: 0.2 mg/cm² |

### Evaluation of Hydrogen Concentration in Oxygen

Under the condition that a water electrolysis cell temperature was 80° C. and the pressure was the atmospheric pressure, water in an amount several times the amount of water required for water electrolysis (water sufficient for carrying out water electrolysis) was circulated to both the oxygen electrode and the hydrogen electrode, and water electrolysis was carried out at a constant current of current density of 2 A/cm² using an electronic load device.

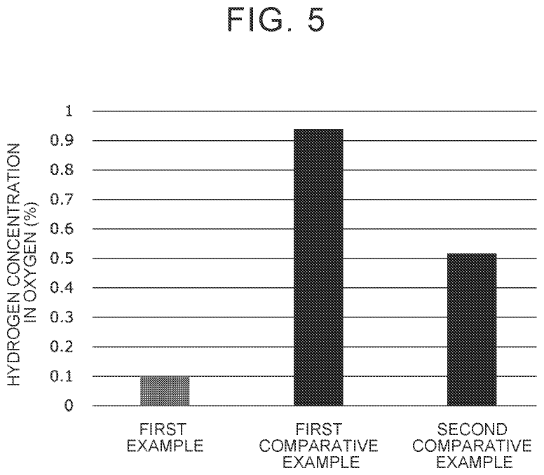

Then, water electrolysis was carried out under the above conditions, the gaseous component and water discharged from the oxygen electrode were separated by the oxygen electrode gas-liquid separator, and the obtained gaseous component was collected for 30 minutes. Then, the concentration of hydrogen in the gaseous component (concentration of hydrogen in oxygen) was measured using gas chromatography-mass spectrometry (GC-MS). The results are shown in FIG. 5 and Table 2.

TABLE 2

| | Hydrogen concentration |
|---|---|
| | in oxygen (%) |
| Example | 0.1 |
| First comparative example | 0.94 |
| Second comparative example | 0.52 |

According to FIG. 5 and Table 2, the hydrogen concentration of the example was the lowest, compared to the hydrogen concentrations of the first and second comparative examples. On the basis of this, it is conceivable that an increase in the hydrogen concentration can be remarkably suppressed when the recombiner is disposed between the water electrolysis cell and the oxygen electrode gas-liquid separator.

What is claimed is:

1. A water electrolysis system comprising:
at least one water electrolysis cell;
a water supply device configured to supply water to an oxygen electrode of the water electrolysis cell;
a water supply channel configured to connect the water electrolysis cell and the water supply device and configured such that the water supplied from the water supply device to the oxygen electrode of the water electrolysis cell flows;
a gas-liquid separator configured to separate the water and a gaseous component discharged from the oxygen electrode of the water electrolysis cell;
a water discharge channel configured to connect the water electrolysis cell and the gas-liquid separator and configured such that the water and the gaseous component discharged from the oxygen electrode of the water electrolysis cell flow; and
a recombiner disposed between the water electrolysis cell and the gas-liquid separator in the water discharge channel, wherein
the recombiner includes a recombination catalyst that reacts hydrogen and oxygen, and
the water electrolysis cell and the recombiner are electrically insulated from each other.

2. The water electrolysis system according to claim 1, wherein:
the recombination catalyst is platinum or a platinum alloy; and
an alloy element in the platinum alloy is at least one metal element selected from a group consisting of Co, Ni, Fe, Mn, Ta, Ti, Hf, W, Zr, Nb, Al, Sn, Mo and Si.

3. The water electrolysis system according to claim 1, wherein
the recombiner includes a housing and a mesh-shaped metal body in which the recombination catalyst is attached to a surface.

4. The water electrolysis system according to claim 1, wherein a potential of the recombiner is 0.8 V or less.
